(19) United States
(12) Patent Application Publication
(10) Pub. No.: US 2011/0197641 A1
(43) Pub. Date: Aug. 18, 2011

(54) FERTILIZING TOP SOIL AND METHOD FOR THE PRODUCTION THEREOF

(76) Inventor: Alberto Volcan, Bolzano (IT)

(21) Appl. No.: 12/734,774

(22) PCT Filed: Nov. 22, 2007
(86) PCT No.: PCT/IB2007/003583

§ 371 Date: Jul. 13, 2010

(51) Int. Cl. C05F 11/02; B02C 19/00

(52) U.S. Cl. 71/24; 241/30

(57) ABSTRACT

A fertilizing humus for plants, which contains vegetal compost for example dried applies for fertilizing the soil in flower pots, gardens, greenhouses, etc is described.

The present invention refers to a fertilizing humus and a procedure for obtaining it.

It is known to use soil in flower pots, for gardens, greenhouses, etc. In order to make this soil sufficiently fertile it must be appropriately fertilized and wet with a certain frequency according to the plant so as to ensure its growth.

The aim of the present invention is to avoid the use of fertilizers as much as possible, first of all, chemical ones which are to be added to the soil for the growth of the plants and to reduce spraying the plants to a minimum.

This aim is reached by a fertilizing humus according to the characterizing part of claim 1 and by a procedure for obtaining it according to claim 3.

The new fertilizing humus called Pixy Flower Power and a procedure for its preparation in a fertilizing vegetal product for plants, flowers, gardening, greenhouses, etc. are described below.

According to the invention the procedure for the preparation comprises the following steps:
Use of a single component of vegetal origin. Dried apple flour or made of other plants of primary/secondary materials, ground from industrial processing waste, in particular from residuals of the production of fruit juices.
Grinding using a 70/200/250 μ (micron) mill.

From various experiments carried out with practical methods, the dried apple vegetal compost is used to fertilize the soil in flower pots, gardens, greenhouses, etc.

This natural product was discovered by chance. Used to fill flower pots, it surprisingly produced unexpected results, as a fertilizer: After a month of its use a remarkable vegetative spurt is noted in the growth of plants and flowers. The fertilizer for example, absorbing and storing a certain number of molecules of water in a certain amount of time, x, releases in a considerably longer period of time than the absorption time, the same quantity of water stored at the start, hence allowing better humidification of products in pots and, therefore, more marked molecular sensitivity where the latter are faced with the normal processes of production and processing adopted up to now.

However, an interesting property of the product in question is noted. In fact, unlike other fertilizers of chemical origin indifferent to any natural transformation, Pixy Flower Power can modify the color of the upper part of the soil contained in the pots, from the original brown color of the apple product to a black “peat” color.

This means quantity transformations in the elements: From apple flour to real perfumed peat.

And as yet there are no contraindications following excessive administration of the product to the radical part of plants. If anything, its abundant distribution in the pots accelerated the reproductive process of the plant as both the color of the leaves and the external appearance of the plant itself are brightened up. Please refer to the following sheet drawn up by the provincial laboratory of Bolzano with regard to the composition of the product.

The administration of Pixy Flower Power has provided another interesting result, which is as follows:

The plants do not require chemical products to be administered by spraying, which means that the natural fertilizer comprises special properties which allow an effective intervention against parasites in the plant or the leaves.

It is not possible to identify the reasons for this latter property whose solution should actually be included in the scientific capabilities of the university laboratory and for which, once the tests have been completed we will ask to be informed of the natural phenomenon observed.

| | | | Unit of |
|---|---|---|---|
| Parameter | Method | Result | measurement |
| Total dietary fiber | ISTISAN reports 96/34 | 47.09 | g/100 g |
| Patulin | SOP-D7-058 rev. 2 of/vom | <2.5 | yg/kg |
| | 15 Dec. 2004 | | |
| Humidity | ISTISAN reports 96/34 | | r g/100 g |
| Ash | ISTISAN reports 96/34 | 1.68 | g/100 g |
| Fat (according to | ISTISAN reports 96/34 | 0.88 | g/100 g |
| Weibull) | | | |
| Protein (N × 6.25) | ISTISAN reports 96/34 | 4.54 | g/100 g |
| Carbohydrate | internal method/interne | 36.59 | g/100 g |
| (calculated as | Methode # | | |
| a difference) | | | |
| Caloric intake 1 | | | |
| Residuals of plant | method | <LOD | mg/kg |
| protection products | | | |
| (see list) | | | |
| Clorpirifos | internal method | 0.74 | mg/kg |

### List of the Active Ingredients Searched For And Their Limits Of Detection (LOD.)/

| | |
|---|---|
| Acephale | 0.02 |
| Alachlor | 0.01 |
| Aldrin | 0.005 |
| Ametrine | 0.01 |
| Atrazine | 0.01 |
| Atrazine-desethyl | 0.01 |
| Azinphos-ethyl | 0.01 |
| Azinphos-methyl | 0.01 |
| Benfluralin | 0.01 |
| Bromopropylate | 0.01 |
| Captafol | 0.01 |
| Captan | 0.02 |
| Cypermethrin | 0.05 |
| Chlorfenvinphos | 0.01 |
| Chlorpyrifos-methyl | 0.01 |
| Chlorothalonil | 0.01 |
| Deltamethrin | 0.1 |
| Diazinon | 0.01 |
| Diclofluanid | 0.01 |
| Dichloran | 0.01 |
| Dichlorvos | 0.01 |
| Dicofol | 0.01 |
| Dicrotophos | 0.01 |
| Dieldrin | 0.005 |
| Dimethoate | 0.01 |
| Alpha endosulfan | 0.01 |
| Endosulfan sulfate | 0.01 |
| Endrin | 0.005 |
| Heptachlor | 0.005 |
| Epoxy heptachlor | 0.005 |
| Hexachlorobenzene | 0.005 |
| Alpha hexachlorocyclohexane | 0.005 |
| Beta hexachlorocyclohexane | 0.005 |
| Delta hexachlorocyclohexane | 0.005 |
| F (lindane) hexachlorocyclohexane | 0.005 |
| Fenarimol | 0.01 |
| Fenitrothion | 0.01 |
| Fenvalerate | 0.5 |
| Folpe | 0.01 |
| Phorate | 0.01 |
| Fosalone | 0.01 |
| Imazalil | 0.1 |
| Iprodione | 0.02 |
| Malathion | 0.01 |
| Metalaxyl | 0.01 |
| Methamidophos | 0.01 |
| Methidathion | 0.01 |
| Methoxychlor | 0.02 |
| Nuarimol | 0.01 |
| Omethoate | 0.02 |
| o.p-DDD | 0.005 |
| o.p-DDE | 0.005 |
| o.p-DDT | 0.005 |
| Parathion | 0.01 |
| Methyl parathion | 0.01 |
| Permethrin | 0.02 |
| Pirimicarb | 0.01 |
| Pirimiphos ethyl | 0.01 |
| Pirimiphos methyl | 0.01 |
| p,p′-DDD | 0.005 |
| p.p′-DDE | 0.005 |
| p,p′-DDT | 0.005 |
| Procymidone | 0.01 |
| Promethrin | 0.01 |
| Propazine | 0.01 |
| Quinalphos | 0.01 |
| Quintozene | 0.01 |
| Simazine | 0.01 |
| Terbuthylazine | 0.01 |
| Terbutryn | 0.01 |
| Tetradifon | 0.01 |
| Tolclofos methyl | 0.01 |
| Vamidothion | 0.02 |
| Vinclozolin | 0.01 |

1-4. (canceled)

5. A fertilizing humus for plants, comprising vegetal compost for example dried applies for fertilizing the soil in flower pots, gardens, greenhouses, etc.

6. The humus according to claim 5, wherein the compost is as follows:

| | | | Unit of |
|---|---|---|---|
| Parameter | Method | Result | measuremen |
| Total dietary fiber | ISTISAN rapport | 47.09 | g/100 g |
| Patulin | SOP-D7-058 rev. 2 of | <2.5 | yg/kg |
| | 15 Dec. 2004 | | |
| Humidity | ISTISAN rapport | | r g/100 g |
| Ash | ISTISAN rapport | 1.68 | g/100 g |
| Fat (according to | ISTISAN rapport | 0.88 | g/100 g |
| Protein (N × 6.25) | ISTISAN rapport | 4.54 | g/100 g |
| Carbohydrate | internal method | 36.59 | g/100 g |
| (calculated as a | | | |
| Caloric intake 1 | | | |
| Residuals of plant | method | <LOD | mg/kg |
| protection products | | | |
| Clorpirifos | internal method | 0.74 | mg/kg |

7. The procedure for obtaining Humus according to claim 5, which comprises the following steps:
Use of a single component of vegetal origin, dried apple flour or made of other plants of primary/secondary materials, ground from industrial processing waste, in particular from residuals of the production of fruit juices.
Grinding using a 70/200/250 μ (micron) mill.

8. The use of humus according to claim 5 for fertilizing soil in flower pots, gardens, greenhouses, etc.

9. The procedure for obtaining Humus according to claim 6, which comprises
the following steps:
Use of a single component of vegetal origin, dried apple flour or made of other plants of primary/secondary materials, ground from industrial processing waste, in particular from residuals of the production of fruit juices.
Grinding using a 70/200/250 μ (micron) mill.
